(19) United States
(12) Patent Application Publication
(10) Pub. No.: US 2016/0165379 A1
(43) Pub. Date: Jun. 9, 2016

(54) Method for Sending Trigger Message and Device

(71) Applicant: Huawei Technologies Co., Ltd., Shenzhen (CN)

(72) Inventors: Qi Yu, Beijing (CN); Wanqiang Zhang, Beijing (CN)

(21) Appl. No.: 15/042,317

(22) Filed: Feb. 12, 2016

Related U.S. Application Data
(63) Continuation of application No. PCT/CN2013/081429, filed on Aug. 14, 2013.

(51) Int. Cl. H04W 4/00; H04W 76/02

(52) U.S. Cl. CPC H04W 4/005; H04W 76/023

(57) ABSTRACT

A method for sending a trigger message and a device. When a third-party application server (AS) needs to establish a connection with machine-to-machine communications user equipment (M2M UE), the third-party AS sends a trigger message to a device trigger application server (DT-AS), where the trigger message includes at least an identifier of the M2M UE, and the DT-AS determines, according to the identifier of the M2M UE, whether the M2M UE has registered with a network at which the DT-AS is located, and when the M2M UE has registered with the network at which the DT-AS is located, sends the trigger message to the M2M UE, in order to implement that the DT-AS identifies the trigger message, such that the M2M UE establishes a connection with the third-party AS.

### CROSS-REFERENCE TO RELATED APPLICATIONS

This application is a continuation of International Application No. PCT/CN2013/081429, filed on Aug. 14, 2013, which is hereby incorporated by reference in its entirety.

### TECHNICAL FIELD

The present disclosure relates to the field of mobile communications technologies, and in particular, to a method for sending a trigger message, and a device.

### BACKGROUND

Machine-to-machine communications (M2M) is a networked application and service that uses smart machine-to-machine interactions as a core. The M2M implement data communication without manual intervention by building a wireless or wired communications module and application processing logic into a machine, in order to meet a requirement of a user for informatization in aspects such as monitoring, scheduling commanding, data collection, and measurement.

Currently, the M2M may be based on a wireless manner and a wired manner. The wireless manner includes a cellular network and short-range transmission, where a 3rd Generation Partnership Project (3GPP) cellular network is a widely used manner. Currently, the 3GPP supports three M2M models, including a direct model, an indirect model, and a hybrid model. The direct model refers to that an M2M application server (AS) directly communicates with a gateway general packet radio service (GPRS) support node (GGSN) or a packet data network gateway (PGW). The indirect model refers to that the AS communicates with the GGSN or the PGW using a service capability server (SCS). In the indirect model, the SCS may be controlled by a 3GPP operator or may be controlled by an M2M service provider. The hybrid model refers to that both the direct model and the indirect model exist.

FIG. 1 is an architectural diagram of a direct model, supported by the European Telecommunications Standards Institute (ETSI) for M2M, for interworking between an M2M network and a 3GPP network in the prior art. A manner is as follows: M2M user equipment (UE) on the left side of FIG. 1 has accessed the 3GPP network and accessed a device trigger application server (DT-AS), where the DT-AS belongs to the 3GPP network, and the DT-AS is a server controlled by an operator, and a machine type communication (MTC) device of a network of the operator may first establish a user plane bearer with the DT-AS. The DT-AS may be a separate logical entity, or a function of the DT-AS may be set in the GGSN or the PGW.

A third-party AS is corresponding to a network service capability layer (NSCL) and a M2M application in the figure. The third-party AS does not belong to the 3GPP network. When the third-party AS needs to establish a connection with the M2M UE, the third-party AS needs to send a trigger message to the M2M UE. According to an existing signaling flow, the third-party AS needs to first send the trigger message destined for the M2M UE to the DT-AS, such that the DT-AS can forward the trigger message to the M2M UE by using an existing connection. The M2M UE acquires an identifier of the third-party AS according to the received trigger message, and establishes a connection with the third-party AS. However, a problem existing in the prior art is that the DT-AS cannot identify the trigger message sent by the third-party AS, such that the trigger message cannot be routed to the M2M UE, and consequently, the M2M UE cannot establish a connection with the third-party AS.

### SUMMARY

Embodiments of the present disclosure provide a method for transmitting a trigger message, which aims to resolve sending of a trigger message from a third-party AS to M2M UE, such that a connection is established between the M2M UE and the third-party AS.

According to a first aspect, a method for sending a trigger message is provided, where the method includes, when a third-party AS needs to establish a connection with M2M UE, sending, by the third-party AS, a trigger message to a DT-AS, where the trigger message includes at least an identifier of the M2M UE, such that the DT-AS determines, according to the identifier of the M2M UE, whether the M2M UE has registered with the DT-AS, and if the M2M UE has registered with the DT-AS, sends the trigger message to the M2M UE, receives a message that is sent by the M2M UE in response to the trigger message, and sends, to the third-party AS, the message in response to the trigger message, and receiving the message that is sent by the DT-AS in response to the trigger message, where the M2M UE is connected to a network at which the DT-AS is located, the DT-AS is a server in a 3GPP network, and the third-party AS is an M2M server outside the 3 GPP network.

With reference to the first aspect, in a first possible implementation manner of the first aspect, before the sending, by the third-party AS, a trigger message to a DT-AS, the method further includes acquiring, by the third-party AS, an Internet Protocol (IP) address of the DT-AS and/or a port number of the DT-AS, and setting an IP address of the third-party AS and/or the port number of the DT-AS that are/is in the trigger message to a preset value or values, where the preset value or value is/are used by the DT-AS to identify the trigger message, or setting the IP address and/or the port number of the DT-AS that are/is in the trigger message to a preset IP address and/or a preset port number respectively, such that when a message is received using the preset IP address and/or the preset port number, the DT-AS can identify the message as the trigger message.

With reference to the first possible implementation manner of the first aspect, in a second possible implementation manner of the first aspect, the acquiring, by the third-party AS, an IP address of the DT-AS and/or a port number of the DT-AS includes acquiring the IP address and/or the port number of the DT-AS that are/is preset in the third-party AS, or acquiring an external IP address, of the M2M UE, preset in the third-party AS, and sending the external IP address to a domain name server (DNS) in order to acquire, by means of parsing, the IP address of the DT-AS.

With reference to the first aspect, the first possible implementation manner of the first aspect, or the second possible implementation manner of the first aspect, in a third possible implementation manner of the first aspect, the third-party AS communicates with the DT-AS using the diameter protocol or the hypertext transfer protocol (HTTP).

According to a second aspect, a method for sending a trigger message is provided, where the method includes receiving, by a DT-AS, a trigger message sent by a third-party application server AS, determining, according to the identifier of the M2M UE, whether the M2M UE has registered with the DT-AS. If the M2M UE has registered with the DT-AS, sending the trigger message to the M2M UE corresponding to the identifier of the M2M UE, and receiving a message that is sent by the M2M UE in response to the trigger message, and sending, to the third-party AS, the message in response to the trigger message, where the trigger message includes at least the identifier of the M2M UE, and the M2M UE is connected to a network at which the DT-AS is located, the DT-AS is a server in a 3GPP network, and the third-party AS is an M2M server outside the 3GPP network.

With reference to the second aspect, in a first possible implementation manner of the second aspect, after the receiving, by a DT-AS, a trigger message sent by the third-party application server AS, the method further includes identifying the trigger message according to a preset specific identifier carried in the trigger message, or identifying the trigger message according to an IP address of the third-party AS and/or a port number of the DT-AS that are/is preset in the trigger message, or when a message is received using a preset IP address and/or a preset port number, identifying, by the DT-AS, the message as the trigger message.

With reference to the second aspect or the first possible implementation manner of the second aspect, in a second possible implementation manner of the second aspect, the third-party AS communicates with the DT-AS using the diameter protocol or the HTTP protocol.

According to a third aspect, an application server is provided, where the application server includes a sending unit configured to, when a third-party application server AS needs to establish a connection with M2M UE, send a trigger message to a DT-AS by the third-party AS, where the trigger message includes at least an identifier of the M2M UE, such that the DT-AS determines, according to the identifier of the M2M UE, whether the M2M UE has registered with the DT-AS, and if the M2M UE has registered with the DT-AS, sends the trigger message to the M2M UE, receives a message that is sent by the M2M UE in response to the trigger message, and sends, to the third-party AS, the message in response to the trigger message, and a receiving unit configured to receive the message that is sent by the DT-AS in response to the trigger message, where the M2M UE is connected to a network at which the DT-AS is located, the DT-AS is a server in a 3GPP network, and the third-party AS is an M2M server outside the 3GPP network.

With reference to the third aspect, in a first possible implementation manner of the third aspect, the application server further includes an acquiring unit and a setting unit, where the acquiring unit is configured to acquire an IP address of the DT-AS and/or a port number of the DT-AS, and the setting unit is configured to set an IP address of the third-party AS and/or the port number of the DT-AS that are/is in the trigger message to a preset value or values, where the preset value or value is/are used by the DT-AS to identify the trigger message, or set the IP address and/or the port number of the DT-AS that are/is in the trigger message to a preset IP address and/or a preset port number respectively, such that when a message is received using the preset IP address and/or the preset port number, the DT-AS can identify the message as the trigger message.

With reference to the first possible implementation manner of the third aspect, in a second possible implementation manner of the third aspect, the acquiring unit is further configured to acquire the IP address and/or the port number of the DT-AS that are/is preset in the third-party AS, or acquire an external IP address, of the M2M UE, preset in the third-party AS, and send the external IP address to a DNS in order to acquire, by means of parsing, the IP address of the DT-AS.

With reference to the third aspect, the first possible implementation manner of the third aspect, or the second possible implementation manner of the third aspect, in a third possible implementation manner of the third aspect, the third-party AS communicates with the DT-AS using the diameter protocol or the HTTP protocol.

According to a fourth aspect, a device trigger application server is provided, where the device trigger application server includes a first receiving unit configured to receive a trigger message sent by a third-party application server AS, where the trigger message includes at least an identifier of M2M UE, a determining unit configured to determine, according to the identifier of the M2M UE, whether the M2M UE has registered with the DT-AS, a sending unit configured to, if the M2M UE has registered with the DT-AS, send the trigger message to the M2M UE corresponding to the identifier of the M2M UE, and a second receiving unit configured to receive a message that is sent by the M2M UE in response to the trigger message, and send, to the third-party AS, the message in response to the trigger message, where the trigger message includes at least the identifier of the M2M UE. The M2M UE is connected to a network at which the DT-AS is located, the DT-AS is a server in a 3GPP network, and the third-party AS is an M2M server outside the 3GPP network.

With reference to the fourth aspect, in a first possible implementation manner of the fourth aspect, the device trigger application server further includes an identifying unit, where the identifying unit is configured to identify the trigger message according to a preset specific identifier carried in the trigger message, or identify the trigger message according to an IP address of the third-party AS and/or a port number of the DT-AS that are/is preset in the trigger message, or when a message is received using a preset IP address and/or a preset port number, identify the message as the trigger message.

With reference to the fourth aspect or the first possible implementation manner of the fourth aspect, in a second possible implementation manner of the fourth aspect, the third-party AS communicates with the DT-AS using the diameter protocol or the HTTP protocol.

The present disclosure provides a method for sending a trigger message. When a third-party AS needs to establish a connection with M2M UE, the third-party AS sends a trigger message to a DT-AS, where the trigger message includes at least an identifier of the M2M UE. The DT-AS determines, according to the identifier of the M2M UE, whether the M2M UE has registered with a network at which the DT-AS is located, and if the M2M UE has registered with the network at which the DT-AS is located, sends the trigger message to the M2M UE, such that the M2M UE establishes a connection with the third-party AS.

### BRIEF DESCRIPTION OF DRAWINGS

To describe the technical solutions in the embodiments of the present disclosure more clearly, the following briefly introduces the accompanying drawings required for describing the embodiments or the prior art. The accompanying drawings in the following description show merely some embodiments of the present disclosure, and a person of ordinary skill in the art may still derive other drawings from these accompanying drawings without creative efforts.

FIG. 1 is an architectural diagram of a direct model, supported by the ETSI, for interworking between an M2M network and a 3GPP network in the prior art;

FIG. 2 is an architectural diagram of an M2M network in the prior art;

FIG. 3 is an architectural diagram of a network in which a second-generation (2G)/third-generation (3G)/long term evolution (LTE) network supports an M2M network in the prior art;

FIG. 4 is an interaction diagram of sending a trigger message in the prior art;

FIG. 5 is an interaction diagram of sending a trigger message according to an embodiment of the present disclosure;

FIG. 6 is a flowchart of a method for sending a trigger message according to an embodiment of the present disclosure;

FIG. 7 is a flowchart of a method for sending a trigger message according to an embodiment of the present disclosure;

FIG. 8 is a flowchart of a method for sending a trigger message according to an embodiment of the present disclosure;

FIG. 9 is a schematic structural diagram of an AS according to an embodiment of the present disclosure;

FIG. 10 is a schematic structural diagram of a DT-AS according to an embodiment of the present disclosure;

FIG. 11 is a schematic structural diagram of M2M UE according to an embodiment of the present disclosure;

FIG. 12 is a schematic structural diagram of an AS according to an embodiment of the present disclosure;

FIG. 13 is a schematic structural diagram of a DT-AS according to an embodiment of the present disclosure; and

FIG. 14 is a schematic structural diagram of M2M UE according to an embodiment of the present disclosure.

### DESCRIPTION OF EMBODIMENTS

To make the objectives, technical solutions, and advantages of the present disclosure clearer and more comprehensible, the following further describes the present disclosure in detail with reference to the accompanying drawings and embodiments. It should be understood that the specific embodiments described herein are merely used to explain the present disclosure but are not intended to limit the present disclosure.

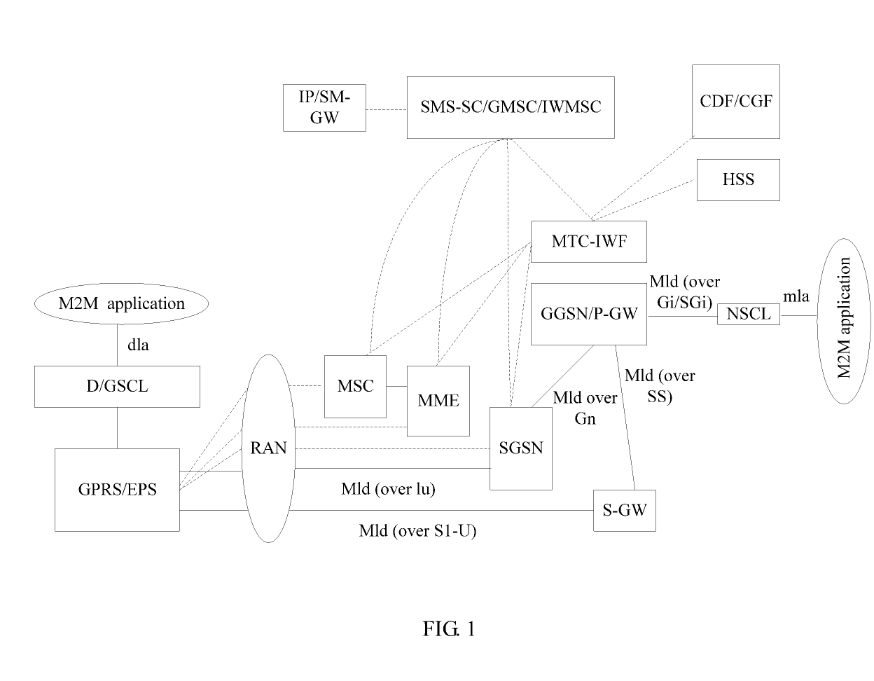

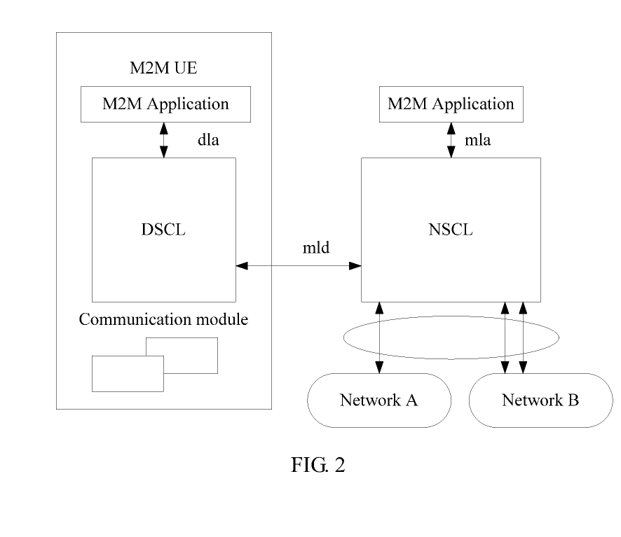

Referring to FIG. 2, FIG. 2 is an architectural diagram of an M2M network in the prior art. An architecture, on the left side of FIG. 1, in which an M2M application and a device/gateway service capability layer (D/GSCL) communicate with each other over a dla interface is equivalent to an architecture, on the left side of FIG. 2, in which an M2M application and a DSCL communicate with each other over a dla interface. An architecture, on the right side of FIG. 1, in which an M2M application and an NSCL communicate with each other over an mla interface is equivalent to an architecture, on the right side of FIG. 2, in which an M2M application and an NSCL communicate with each other over an mla interface. On M2M UE, an M2M device application (DA) communicates with an M2M DSCL over a dla interface. On the side of an M2M network, an M2M network application (NA) communicates with an M2M NSCL over an mla interface. The ETSI for M2M defines an mld interface between the DSCL and the NSCL. The M2M NA may access and load the M2M DA on the M2M UE over the mld interface.

Currently, the M2M communications may be based on a wireless manner and a wired manner. The wireless manner includes a cellular network and short-range transmission, and a 3GPP cellular network is a widely used manner.

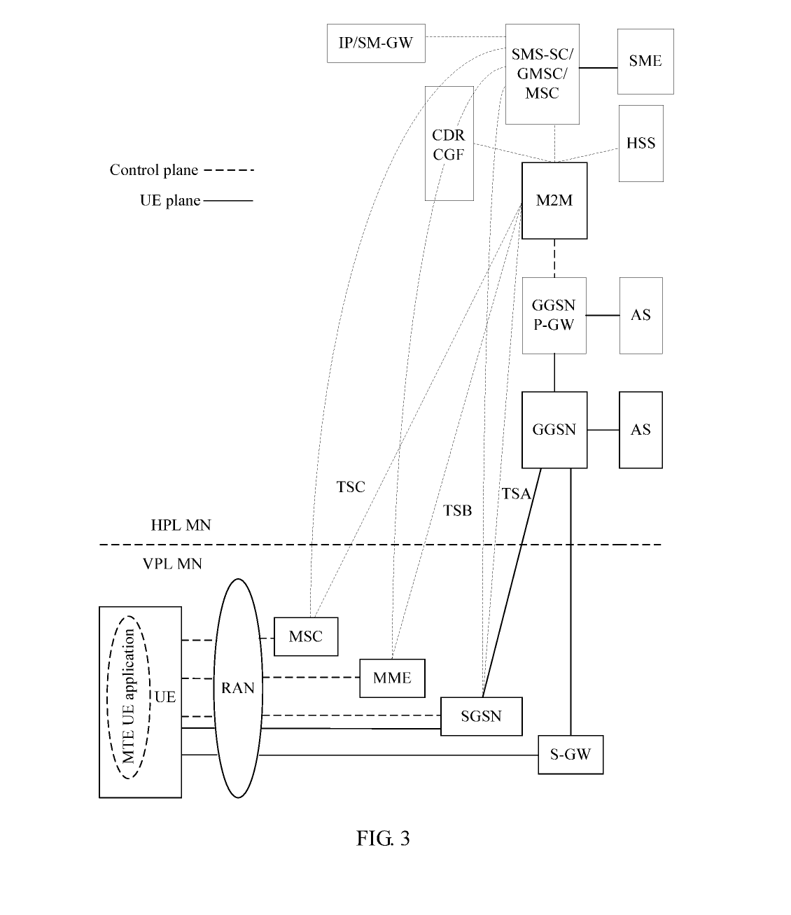

Referring to FIG. 3, FIG. 3 is an architectural diagram of a network in which a 2G/3G/LTE network supports an M2M network in the prior art. Based on the network architecture in FIG. 3, UE on the left side of FIG. 3 is replaced with the M2M architecture on the left side of FIG. 2 and an AS on the right side of FIG. 3 is replaced with the M2M architecture on the right side of FIG. 2, to form the architectural diagram of the network in FIG. 1. FIG. 3 shows related nodes on a user plane in a direct model. A 3G core network mainly includes three logical function entities: a serving GPRS support node (SGSN), a serving gateway, and a PGW. A DT-AS is a server controlled by an operator, and an MTC device in a network of the operator may first establish a user plane bearer with the DT-AS. The DT-AS may be a separate logic entity, or may be co-located with a GGSN or a PGW.

The AS is an external third-party server, and is mapped, in the present disclosure, to an NSCL of the ETSI and an application.

Currently, the 3GPP supports three M2M models, including a direct model, an indirect model, and a hybrid model. The present disclosure relates to the direct model, where the direct model refers to that the AS directly communicates with the GGSN or the PGW.

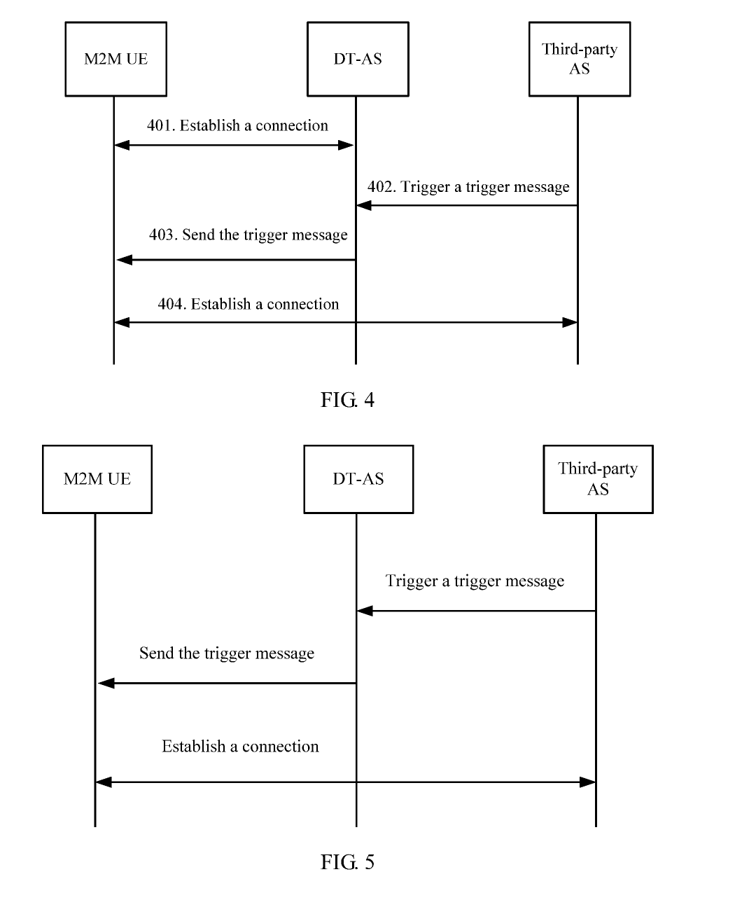

Referring to FIG. 4, FIG. 4 is an interaction diagram of sending a trigger message in the prior art. As shown in FIG. 4, M2M UE establishes a network connection with a DT-AS, where the DT-AS is a server in a 3GPP network, the third-party AS is an M2M server outside the 3GPP network, the M2M UE registers with the third-party AS in advance, and the third-party AS stores related information about the M2M UE, including an identifier of the M2M UE. When the third-party AS needs to establish a connection with the M2M UE, the third-party AS triggers a trigger message.

Step 401: The M2M UE establishes a network connection with the DT-AS.

Step 402: When the third-party AS needs to establish a connection with the M2M UE, the third-party AS triggers a trigger message and sends the trigger message to the DT-AS, and the DT-AS receives the trigger message sent by the third-party AS.

Step 403: The DT-AS sends the trigger message to the M2M UE.

Step 404: The M2M UE establishes a connection with the third-party AS.

In step 402, the DT-AS cannot identify the trigger message sent by the AS, such that the trigger message cannot be sent to the M2M UE, and the M2M UE cannot establish a network connection with the third-party AS.

The M2M UE is connected to a network at which the DT-AS is located, the DT-AS is a server in a 3GPP network, and the third-party AS is an M2M server outside the 3GPP network.

Referring to FIG. 5, FIG. 5 is an interaction diagram of sending a trigger message according to an embodiment of the present disclosure. As shown in FIG. 5, an M2M UE establishes a network connection with a DT-AS, where the DT-AS is a server in a 3GPP network, the third-party AS is an M2M server outside the 3GPP network, the M2M UE registers with the third-party AS in advance, and the third-party AS stores related information about the M2M UE, including an identifier of the M2M UE. When the third-party AS needs to acquire data of the M2M UE, the third-party AS triggers a trigger message. For example, it is assumed that the third-party AS is a server of an electricity meter company. When the electricity meter company needs to report data of an electricity meter of user equipment, the third-party AS needs to trigger a trigger message, carry an identifier of the user equipment in the trigger message, and send the trigger message to the DT-AS. The DT-AS determines, according to the identifier of the user equipment, whether the user equipment has registered with the 3GPP network, and if the user equipment has registered with the 3GPP network, the DT-AS sends the trigger message to the M2M UE, such that the M2M UE establishes a connection with the third-party AS, and the server of the electricity meter company can read the data of the electricity meter of the user equipment.

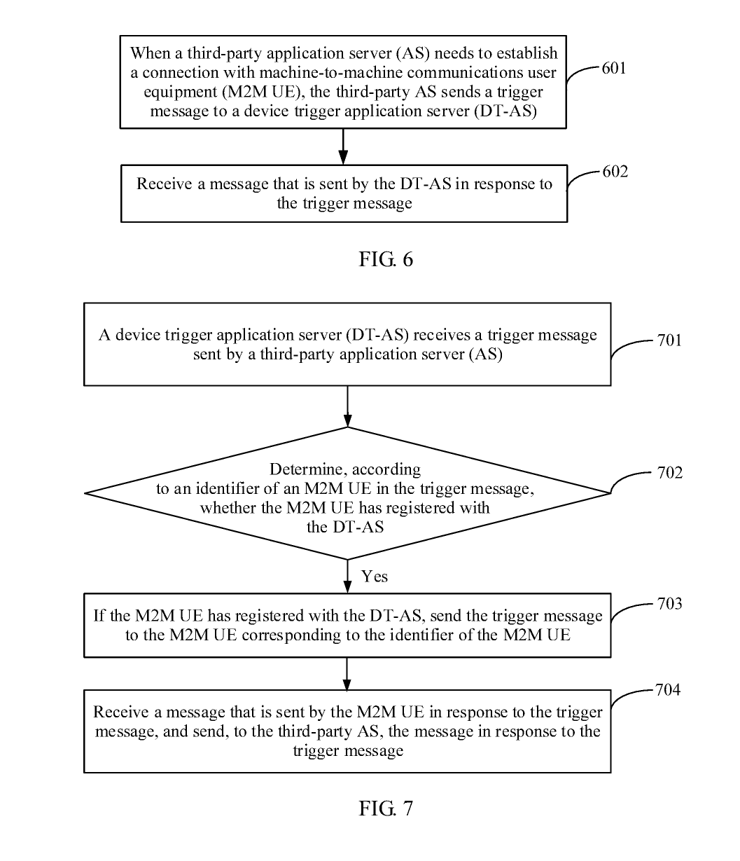

Referring to FIG. 6, FIG. 6 is a flowchart of a method for sending a trigger message according to an embodiment of the present disclosure. As shown in FIG. 6, the method includes the following steps:

Step 601: When a third-party application server (AS) needs to establish a connection with machine-to-machine communications user equipment (M2M UE), the third-party AS sends a trigger message to a device trigger application server (DT-AS).

The trigger message includes at least an identifier of the M2M UE, such that the DT-AS determines, according to the identifier of the M2M UE, whether the M2M UE has registered with the DT-AS, and if the M2M UE has registered with the DT-AS, sends the trigger message to the M2M UE, receives a message that is sent by the M2M UE in response to the trigger message, and sends, to the third-party AS, the message in response to the trigger message.

Furthermore, as shown in FIG. 5, when the third-party AS needs to establish a connection with the M2M UE, the third-party AS sends a trigger message to the device trigger application server DT-AS.

Optionally, when the DT-AS determines, according to the identifier of the M2M UE, that the M2M UE has not registered with the DT-AS, the DT-AS returns a response to the third-party AS, where a failure cause is carried in the response.

Step 602: Receive a message that is sent by the DT-AS in response to the trigger message.

The third-party AS prestores the identifier of the M2M UE, the M2M UE is connected to a network at which the DT-AS is located, the DT-AS is a server in a 3GPP network, and the third-party AS is an M2M server outside the 3GPP network.

Furthermore, when the M2M UE registers with the third-party AS, the third-party AS prestores the identifier of the M2M UE.

Optionally, before the sending, by the third-party AS, the trigger message to the DT-AS, the method further includes acquiring, by the third-party AS, an IP address of the DT-AS and/or a port number of the DT-AS, and setting an IP address of the third-party AS and/or the port number of the DT-AS that are/is in the trigger message to a preset value or values, where the preset value or value is/are used by the DT-AS to identify the trigger message, or setting the IP address and/or the port number of the DT-AS that are/is in the trigger message to a preset IP address and/or a preset port number respectively, such that when a message is received using the preset IP address and/or the preset port number, the DT-AS can identify the message as the trigger message.

Furthermore, the third-party AS may set the IP address of the third-party AS in the trigger message to 1.1.0.0, and the DT-AS and the third-party AS agree, in advance, on that when the IP address of the third-party AS is 1.1.0.0, the DT-AS can identify the message as the trigger message.

The third-party AS may set the port number of the DT-AS in the trigger message to 1, and the DT-AS and the third-party AS agree, in advance, on that when the port number of the DT-AS in the trigger message is 1, the DT-AS can identify the message as the trigger message.

The third-party AS may set the IP address and the port number of the DT-AS in the trigger message to 1.1.1.1 and 0 respectively, and when a trigger message is received using the IP address 1.1.1.1 and the port number 0, the DT-AS can identify the message as the trigger message.

The acquiring, by the third-party AS, an IP address of the DT-AS and/or a port number of the DT-AS includes acquiring the IP address and/or the port number of the DT-AS that are/is preset in the third-party AS or acquiring an external IP address, of the M2M UE, preset in the third-party AS, and sending the external IP address to a DNS in order to acquire, by means of parsing, the IP address of the DT-AS.

The third-party AS communicates with the DT-AS using the diameter protocol or the HTTP protocol.

The present disclosure provides a method for sending a trigger message. When a third-party AS needs to establish a connection with M2M UE, the third-party AS sends a trigger message to a DT-AS, where the trigger message includes at least an identifier of the M2M UE. The DT-AS determines, according to the identifier of the M2M UE, whether the M2M UE has registered with a network at which the DT-AS is located, and if the M2M UE has registered with the network at which the DT-AS is located, sends the trigger message to the M2M UE, in order to implement that the DT-AS identifies the trigger message, such that the M2M UE establishes a connection with the third-party AS.

Referring to FIG. 7, FIG. 7 is a flowchart of a method for sending a trigger message according to an embodiment of the present disclosure. As shown in FIG. 7, the method includes the following steps:

Step 701: A device trigger application server (DT-AS) receives a trigger message sent by a third-party application server (AS), where the trigger message includes at least an identifier of machine-to-machine communications user equipment M2M UE.

Referring to FIG. 5, when the third-party AS needs to access the M2M UE, the third-party AS triggers a trigger message and sends the trigger message to the DT-AS, and the DT-AS receives the trigger message sent by the third-party AS.

Step 702: Determine, according to an identifier of an M2M UE in the trigger message, whether the M2M UE has registered with the DT-AS.

Furthermore, the trigger message carries the identifier of the M2M UE, and the DT-AS determines, according to the identifier of the M2M UE, whether the M2M UE has registered with a network at which the DT-AS is located.

Step 703: If the M2M UE has registered with the DT-AS, send the trigger message to the M2M UE corresponding to the identifier of the M2M UE.

Step 704: Receive a message that is sent by the M2M UE in response to the trigger message, and send, to the third-party AS, the message in response to the trigger message.

The third-party AS prestores the identifier of the M2M UE, the M2M UE is connected to a network at which the DT-AS is located, the DT-AS is a server in a 3GPP network, and the third-party AS is an M2M server outside the 3GPP network.

Optionally, after the DT-AS receives the trigger message sent by the third-party AS, the method further includes identifying the trigger message according to a preset specific identifier carried in the trigger message, or identifying the trigger message according to an IP address of the third-party AS and/or a port number of the DT-AS that are/is preset in the trigger message, or when a message is received using a preset IP address and/or a preset port number, identifying, by the DT-AS, the message as the trigger message.

Furthermore, when the third-party AS carries a specific identifier A in the trigger message, the DT-AS and the third-party AS agree, in advance, on that when the trigger message carries the specific identifier A, the DT-AS can identify the message as the trigger message.

The third-party AS may set the IP address of the third-party AS in the trigger message to 1.1.0.0, and the DT-AS and the third-party AS agree, in advance, on that when the IP address of the third-party AS is 1.1.0.0, the DT-AS can identify the message as the trigger message.

The third-party AS may set the port number of the DT-AS in the trigger message to 1, and the DT-AS and the third-party AS agree, in advance, on that when the port number of the DT-AS in the trigger message is 1, the DT-AS can identify the message as the trigger message.

The third-party AS may set an IP address and the port number of the DT-AS in the trigger message to 1.1.1.1 and 0 respectively, and when a trigger message is received using the IP address 1.1.1.1 and the port number 0, the DT-AS can identify the message as the trigger message.

The third-party AS communicates with the DT-AS using the diameter protocol or the HTTP protocol.

The present disclosure provides a method for sending a trigger message. When a third-party AS needs to establish a connection with M2M UE, the third-party AS sends a trigger message to a DT-AS, where the trigger message includes at least an identifier of the M2M UE. The DT-AS determines, according to the identifier of the M2M UE, whether the M2M UE has registered with a network at which the DT-AS is located, and if the M2M UE has registered with the network at which the DT-AS is located, sends the trigger message to the M2M UE, in order to implement that the DT-AS identifies the trigger message, such that the M2M UE establishes a connection with the third-party AS.

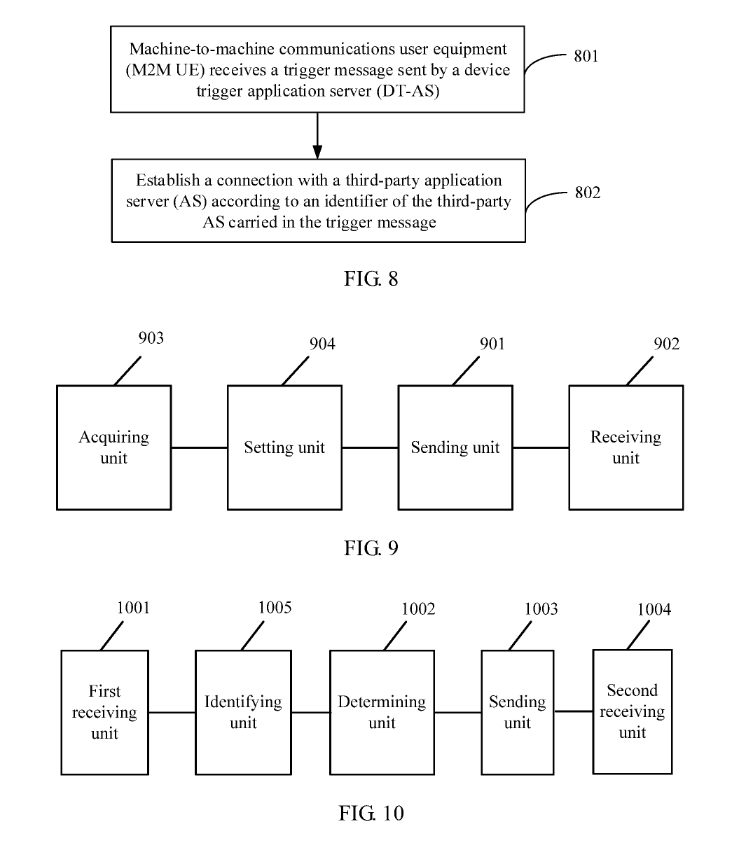

Referring to FIG. 8, FIG. 8 is a flowchart of a method for sending a trigger message according to an embodiment of the present disclosure. As shown in FIG. 8, the method includes the following steps.

Step 801: Machine-to-machine communications user equipment (M2M UE) receives a trigger message sent by a device trigger application server (DT-AS).

Referring to FIG. 5, when the DT-AS sends a trigger message to the M2M UE, the M2M UE receives the trigger message.

Step 802: Establish a connection with a third-party application server (AS) according to an identifier of the third-party AS carried in the trigger message.

The trigger message includes at least an identifier of the M2M UE.

The third-party AS prestores the identifier of the M2M UE, the M2M UE is connected to a network at which the DT-AS is located, the DT-AS is a server in a 3GPP network, and the third-party AS is an M2M server outside the 3GPP network.

The present disclosure provides a method for sending a trigger message. When a third-party AS needs to establish a connection with M2M UE, the third-party AS sends a trigger message to a DT-AS, where the trigger message includes at least an identifier of the M2M UE. The DT-AS determines, according to the identifier of the M2M UE, whether the M2M UE has registered with a network at which the DT-AS is located, and if the M2M UE has registered with the network at which the DT-AS is located, sends the trigger message to the M2M UE, in order to implement that the DT-AS identifies the trigger message, such that the M2M UE establishes a connection with the third-party AS.

Referring to FIG. 9, FIG. 9 is a schematic structural diagram of an AS according to an embodiment of the present disclosure. As shown in FIG. 9, the application server includes a sending unit 901 and a receiving unit 902.

The sending unit 901 is configured to, when the third-party AS needs to establish a connection with M2M UE, send a trigger message to a DT-AS by the third-party AS.

The trigger message includes at least an identifier of the M2M UE, such that the DT-AS determines, according to the identifier of the M2M UE, whether the M2M UE has registered with the DT-AS, and if the M2M UE has registered with the DT-AS, sends the trigger message to the M2M UE, receives a message that is sent by the M2M UE in response to the trigger message, and sends, to the third-party AS, the message in response to the trigger message.

Furthermore, as shown in FIG. 5, when the third-party AS needs to establish a connection with the M2M UE, the third-party AS sends a trigger message to the DT-AS.

The receiving unit 902 is configured to receive the message that is sent by the DT-AS in response to the trigger message.

The third-party AS prestores the identifier of the M2M UE, the M2M UE is connected to a network at which the DT-AS is located, the DT-AS is a server in a 3GPP network, and the third-party AS is an M2M server outside the 3GPP network.

Furthermore, when the M2M UE registers with the third-party AS, the third-party AS prestores the identifier of the M2M UE.

The AS further includes an acquiring unit 903 and a setting unit 904.

The acquiring unit 903 is configured to acquire an IP address of the DT-AS and/or a port number of the DT-AS.

The setting unit 904 is configured to set an IP address of the third-party AS and/or the port number of the DT-AS that are/is in the trigger message to a preset value or values, where the preset value or value is/are used by the DT-AS to identify the trigger message, or set the IP address and/or the port number of the DT-AS that are/is in the trigger message to a preset IP address and/or a preset port number respectively, such that when a message is received using the preset IP address and/or the preset port number, the DT-AS can identify the message as the trigger message.

Furthermore, the third-party AS may set the IP address of the third-party AS in the trigger message to 1.1.0.0, and the DT-AS and the third-party AS agree, in advance, on that when the IP address of the third-party AS is 1.1.0.0, the DT-AS can identify the message as the trigger message.

The third-party AS may set the port number of the DT-AS in the trigger message to 1, and the DT-AS and the third-party AS agree, in advance, on that when the port number of the DT-AS in the trigger message is 1, the DT-AS can identify the message as the trigger message.

The third-party AS may set an IP address and the port number of the DT-AS in the trigger message to 1.1.1.1 and 0 respectively, and when a trigger message is received using the IP address 1.1.1.1 and the port number 0, the DT-AS can identify the message as the trigger message.

The acquiring unit 903 is further configured to acquire the IP address and/or the port number of the DT-AS that are/is preset in the third-party AS, or acquire an external IP address, of the M2M UE, preset in the third-party AS, and send the external IP address to a DNS in order to acquire, by means of parsing, the IP address of the DT-AS.

The third-party AS communicates with the DT-AS using the diameter protocol or the HTTP protocol.

The present disclosure provides a device for sending a trigger message. When a third-party AS needs to establish a connection with M2M UE, the third-party AS sends a trigger message to a DT-AS, where the trigger message includes at least an identifier of the M2M UE. The DT-AS determines, according to the identifier of the M2M UE, whether the M2M UE has registered with a network at which the DT-AS is located, and if the M2M UE has registered with the network at which the DT-AS is located, sends the trigger message to the M2M UE, in order to implement that the DT-AS identifies the trigger message, such that the M2M UE establishes a connection with the third-party AS.

Referring to FIG. 10, FIG. 10 is a schematic structural diagram of a DT-AS according to an embodiment of the present disclosure. As shown in FIG. 10, the DT-AS includes a first receiving unit 1001, a determining unit 1002, a sending unit 1003, and a second receiving unit 1004.

The first receiving unit 1001 is configured to receive a trigger message sent by a third-party AS, where the trigger message includes at least an identifier of M2M UE.

Referring to FIG. 5, when the third-party AS needs to access the M2M UE, the third-party AS triggers a trigger message and sends the trigger message to the DT-AS, and the DT-AS receives the trigger message sent by the third-party AS.

The determining unit 1002 is configured to determine, according to the identifier of the M2M UE, whether the M2M UE has registered with the DT-AS.

Furthermore, the trigger message carries the identifier of the M2M UE, and the DT-AS determines, according to the identifier of the M2M UE, whether the M2M UE has registered with a network at which the DT-AS is located.

The sending unit 1003 is configured to, if the M2M UE has registered with the DT-AS, send the trigger message to the M2M UE corresponding to the identifier of the M2M UE.

The second receiving unit 1004 is configured to receive a message that is sent by the M2M UE in response to the trigger message, and send, to the third-party AS, the message in response to the trigger message.

The third-party AS prestores the identifier of the M2M UE, the M2M UE is connected to a network at which the DT-AS is located, the DT-AS is a server in a 3GPP network, and the third-party AS is an M2M server outside the 3GPP network.

The DT-AS further includes an identifying unit 1005, where the identifying unit 1005 is configured to identify the trigger message according to a preset specific identifier carried in the trigger message, or identify the trigger message according to an IP address of the third-party AS and/or a port number of the DT-AS that are/is preset in the trigger message, or when a message is received using a preset IP address and/or a preset port number, identify the message as the trigger message.

Furthermore, when the third-party AS carries a specific identifier A in the trigger message, the DT-AS and the third-party AS agree, in advance, on that when the trigger message carries the specific identifier A, the DT-AS can identify the message as the trigger message.

The third-party AS may set the IP address of the third-party AS in the trigger message to 1.1.0.0, and the DT-AS and the third-party AS agree, in advance, on that when the IP address of the third-party AS is 1.1.0.0, the DT-AS can identify the message as the trigger message.

The third-party AS may set the port number of the DT-AS in the trigger message to 1, and the DT-AS and the third-party AS agree, in advance, on that when the port number of the DT-AS in the trigger message is 1, the DT-AS can identify the message as the trigger message.

The third-party AS may set an IP address and the port number of the DT-AS in the trigger message to 1.1.1.1 and 0 respectively, and when a trigger message is received using the IP address 1.1.1.1 and the port number 0, the DT-AS can identify the message as the trigger message.

The third-party AS communicates with the DT-AS using the diameter protocol or the HTTP protocol.

The present disclosure provides a device for sending a trigger message. When a third-party AS needs to establish a connection with M2M UE, the third-party AS sends a trigger message to a DT-AS, where the trigger message includes at least an identifier of the M2M UE. The DT-AS determines, according to the identifier of the M2M UE, whether the M2M UE has registered with a network at which the DT-AS is located, and if the M2M UE has registered with the network at which the DT-AS is located, sends the trigger message to the M2M UE, in order to implement that the DT-AS identifies the trigger message, such that the M2M UE establishes a connection with the third-party AS.

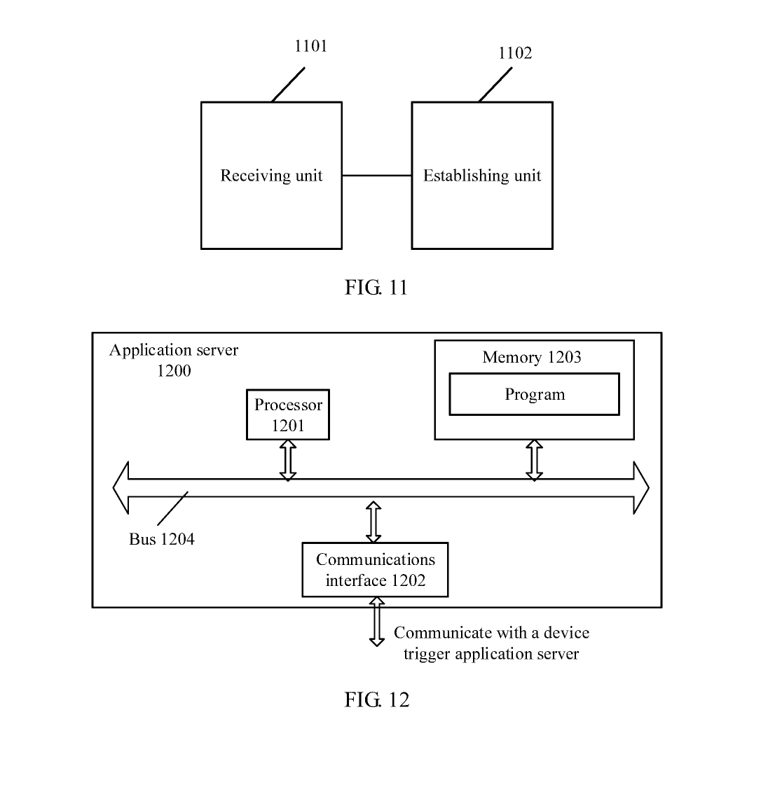

Referring to FIG. 11, FIG. 11 is a schematic structural diagram of an M2M UE according to an embodiment of the present disclosure. As shown in FIG. 11, the M2M UE includes a receiving unit 1101 and an establishing unit 1102.

The receiving unit 1101 is configured to receive a trigger message sent by a DT-AS.

Referring to FIG. 5, when the DT-AS sends a trigger message to the M2M UE, the M2M UE receives the trigger message.

The establishing unit 1102 is configured to establish a connection with a third-party AS according to an identifier of the third-party AS carried in the trigger message.

The trigger message includes at least an identifier of the M2M UE.

The third-party AS prestores the identifier of the M2M UE, the M2M UE is connected to a network at which the DT-AS is located, the DT-AS is a server in a 3GPP network, and the third-party AS is an M2M server outside the 3GPP network.

The present disclosure provides a device for sending a trigger message. When a third-party AS needs to establish a connection with M2M UE, the third-party AS sends a trigger message to a DT-AS, where the trigger message includes at least an identifier of the M2M UE. The DT-AS determines, according to the identifier of the M2M UE, whether the M2M UE has registered with a network at which the DT-AS is located, and if the M2M UE has registered with the network at which the DT-AS is located, sends the trigger message to the M2M UE, in order to implement that the DT-AS identifies the trigger message, such that the M2M UE establishes a connection with the third-party AS.

Referring to FIG. 12, FIG. 12 is a schematic structural diagram of an AS according to an embodiment of the present disclosure. Referring to FIG. 12, FIG. 12 shows the application server 1200 provided in this embodiment of the present disclosure, and a specific embodiment of the present disclosure imposes no limitation on specific implementation of the application server. The application server 1200 includes a processor 1201, a communications interface 1202, a memory 1203, and a bus 1204.

The processor 1201, the communications interface 1202, and the memory 1203 complete mutual communication using the bus 1204.

The communications interface 1202 is configured to communicate with a DT-AS.

The processor 1201 is configured to execute a program.

Furthermore, the program may include program code, where the program code includes a computer operation instruction.

The processor 1201 may be a central processing unit (CPU).

The memory 1203 is configured to store a program. The memory 1203 may be a volatile memory such as a random access memory (RAM), or a nonvolatile memory such as a flash memory, a hard disk drive (HDD), or a solid state drive (SSD). The processor 1201 executes, according to a program instruction stored in the memory 1203, the following method, when the third-party AS needs to establish a connection with M2M UE, sending, by the third-party AS, a trigger message to a DT-AS, where the trigger message includes at least an identifier of the M2M UE, such that the DT-AS determines, according to the identifier of the M2M UE, whether the M2M UE has registered with the DT-AS, and if the M2M UE has registered with the DT-AS, sends the trigger message to the M2M UE, receives a message that is sent by the M2M UE in response to the trigger message, and sends, to the third-party AS, the message in response to the trigger message, and receiving the message that is sent by the DT-AS in response to the trigger message, where the M2M UE is connected to a network at which the DT-AS is located, the DT-AS is a server in a 3GPP network, and the third-party AS is an M2M server outside the 3GPP network.

Before the sending, by the third-party AS, a trigger message to the DT-AS, the method further includes acquiring, by the third-party AS, an IP address of the DT-AS and/or a port number of the DT-AS, and setting an IP address of the third-party AS and/or the port number of the DT-AS that are/is in the trigger message to a preset value or values, where the preset value or value is/are used by the DT-AS to identify the trigger message, or setting the IP address and/or the port number of the DT-AS that are/is in the trigger message to a preset IP address and/or a preset port number respectively, such that when a message is received using the preset IP address and/or the preset port number, the DT-AS can identify the message as the trigger message.

The acquiring, by the third-party AS, an IP address of the DT-AS and/or a port number of the DT-AS includes acquiring the IP address and/or the port number of the DT-AS that are/is preset in the third-party AS, or acquiring an external IP address, of the M2M UE, preset in the third-party AS, and sending the external IP address to a DNS in order to acquire, by means of parsing, the IP address of the DT-AS, or acquiring an IP address of the DT-AS that is preset in the third-party AS, and sending the IP address of the DT-AS to a DNS in order to acquire, by means of parsing, the IP address of the DT-AS.

The third-party AS communicates with the DT-AS using the diameter protocol or the HTTP protocol.

The present disclosure provides a method for sending a trigger message. When a third-party AS needs to establish a connection with M2M UE, the third-party AS sends a trigger message to a DT-AS, where the trigger message includes at least an identifier of the M2M UE. The DT-AS determines, according to the identifier of the M2M UE, whether the M2M UE has registered with a network at which the DT-AS is located, and if the M2M UE has registered with the network at which the DT-AS is located, sends the trigger message to the M2M UE, in order to implement that the DT-AS identifies the trigger message, such that the M2M UE establishes a connection with the third-party AS.

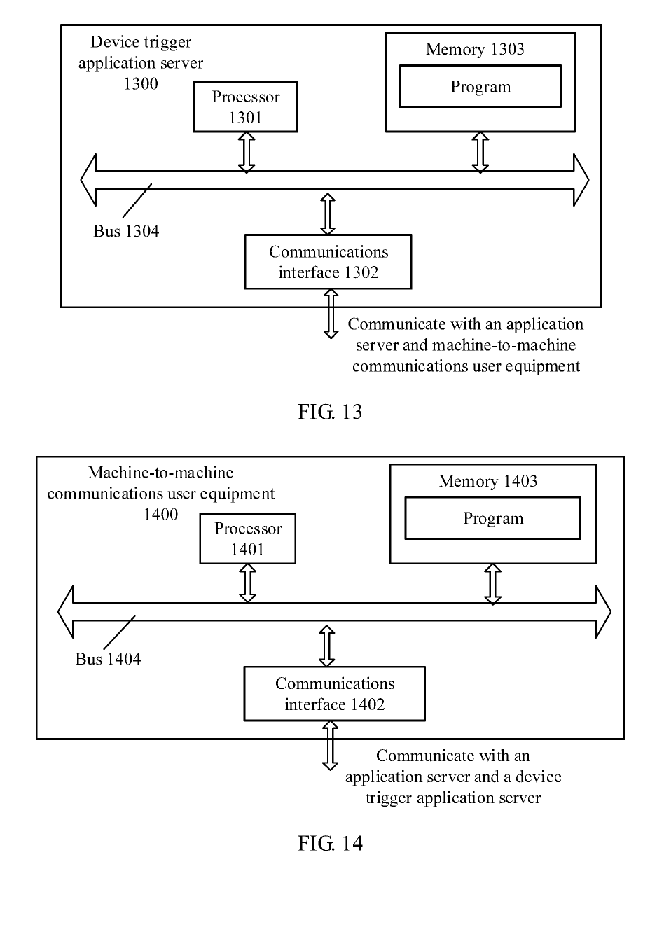

Referring to FIG. 13, FIG. 13 is a schematic structural diagram of a DT-AS according to an embodiment of the present disclosure. Referring to FIG. 13, FIG. 13 shows the device trigger application server 1300 provided in this embodiment of the present disclosure, and a specific embodiment of the present disclosure imposes no limitation on specific implementation of the device trigger application server. The device trigger application server 1300 includes a processor 1301, a communications interface 1302, a memory 1303, and a bus 1304.

The processor 1301, the communications interface 1302, and the memory 1303 complete mutual communications using the bus 1304.

The communications interface 1302 is configured to communicate with an AS and M2M UE.

The processor 1301 is configured to execute a program.

Furthermore, the program may include program code, where the program code includes a computer operation instruction.

The processor 1301 may be a CPU.

The memory 1303 is configured to store a program. The memory 1303 may be a volatile memory such as a RAM, or a nonvolatile memory such as a flash memory, a HDD, or a SSD. The processor 1301 executes, according to a program instruction stored in the memory 1303, the following method receiving a trigger message sent by a third-party AS, where the trigger message includes at least an identifier of M2M UE, determining, according to the identifier of the M2M UE, whether the M2M UE has registered with the DT-AS. If the M2M UE has registered with the DT-AS, sending the trigger message to the M2M UE corresponding to the identifier of the M2M UE, and receiving a message that is sent by the M2M UE in response to the trigger message, and sending, to the third-party AS, the message in response to the trigger message.

The trigger message includes at least an identifier of the M2M UE.

The M2M UE is connected to a network at which the DT-AS is located, the DT-AS is a server in a 3GPP network, and the third-party AS is an M2M server outside the 3GPP network.

After the receiving, by a DT-AS, a trigger message sent by the third-party AS, the method further includes identifying the trigger message according to a preset specific identifier carried in the trigger message, or identifying the trigger message according to an IP address of the third-party AS and/or a port number of the DT-AS that are/is preset in the trigger message, or when a message is received using a preset IP address and/or a preset port number, identifying, by the DT-AS, the message as the trigger message.

The third-party AS communicates with the DT-AS using the diameter protocol or the HTTP protocol.

The present disclosure provides a DT-AS. When a third-party AS needs to establish a connection with M2M UE, the third-party AS sends a trigger message to the DT-AS, where the trigger message includes at least an identifier of the M2M UE. The DT-AS determines, according to the identifier of the M2M UE, whether the M2M UE has registered with a network at which the DT-AS is located, and if the M2M UE has registered with the network at which the DT-AS is located, sends the trigger message to the M2M UE, in order to implement that the DT-AS identifies the trigger message, such that the M2M UE establishes a connection with the third-party AS.

Referring to FIG. 14, FIG. 14 is a schematic structural diagram of M2M UE according to an embodiment of the present disclosure. Referring to FIG. 14, FIG. 14 shows the machine-to-machine communications user equipment 1400 provided in this embodiment of the present disclosure, and a specific embodiment of the present disclosure imposes no limitation on specific implementation of the machine-to-machine communications user equipment. The M2M UE 1400 includes a processor 1401, a communications interface 1402, a memory 1403, and a bus 1404.

The processor 1401, the communications interface 1402, and the memory 1403 complete mutual communications using the bus 1404.

The communications interface 1402 is configured to communicate with an AS and a DT-AS.

The processor 1401 is configured to execute a program.

Furthermore, the program may include program code, where the program code includes a computer operation instruction.

The processor 1401 may be a CPU.

The memory 1403 is configured to store a program. The memory 1403 may be a volatile memory such as a RAM, or a nonvolatile memory such as a flash memory, a HDD, or a SDD. The processor 1401 executes, according to a program instruction stored in the memory 1403, the following method receiving a trigger message sent by the DT-AS, and establishing a connection with a third-party AS according to an identifier of the third-party AS carried in the trigger message.

The trigger message includes at least an identifier of the M2M UE.

The third-party AS prestores the identifier of the M2M UE, the M2M UE is connected to a network at which the DT-AS is located, the DT-AS is a server in a 3GPP network, and the third-party AS is an M2M server outside the 3GPP network.

The present disclosure provides M2M UE. When a third-party AS needs to establish a connection with the M2M UE, the third-party AS sends a trigger message to a DT-AS, where the trigger message includes at least an identifier of the M2M UE. The DT-AS determines, according to the identifier of the M2M UE, whether the M2M UE has registered with a network at which the DT-AS is located, and if the M2M UE has registered with the network at which the DT-AS is located, sends the trigger message to the M2M UE, in order to implement that the DT-AS identifies the trigger message, such that the M2M UE establishes a connection with the third-party AS.

The foregoing descriptions are merely exemplary embodiments of the present disclosure, but are not intended to limit the present disclosure. Any modification, equivalent replacement, or improvement made without departing from the spirit and principle of the present disclosure should fall within the protection scope of the present disclosure

What is claimed is:

1. A method for sending a trigger message, comprising:
sending, by a third-party application server (AS), the trigger message to a device trigger application server (DT-AS) when the third-party AS needs to establish a connection with machine-to-machine communications user equipment (M2M UE), wherein the trigger message comprises at least an identifier of the M2M UE;
determining, by the DT-AS, according to the identifier of the M2M UE, whether the M2M UE has registered with the DT-AS;
sending the trigger message, by the DT-AS, to the M2M UE when the M2M UE has registered with the DT-AS;
receiving, by the DT-AS, another message that is sent by the M2M UE in response to the trigger message;
sending, by the DT-AS, to the third-party AS, the message in response to the trigger message; and
receiving, by the third party AS, the message that is sent by the DT-AS in response to the trigger message, wherein the M2M UE is connected to a network at which the DT-AS is located, wherein the DT-AS is a server in a third Generation Partnership Project (3GPP) network, and wherein the third-party AS is a machine-to-machine communications (M2M) server outside the 3GPP network.

2. The method according to claim 1, wherein before sending, by the third-party AS, the trigger message to the DT-AS, the method further comprises:
acquiring, by the third-party AS, an Internet Protocol (IP) address of the DT-AS and/or a port number of the DT-AS; and
setting an IP address of the third-party AS and/or the port number of the DT-AS that are/is in the trigger message to a preset value or values, wherein the preset value or value is/are used by the DT-AS to identify the trigger message.

3. The method according to claim 1, wherein before sending, by the third-party AS, the trigger message to the DT-AS, the method further comprises:
acquiring, by the third-party AS, an Internet Protocol (IP) address of the DT-AS and/or a port number of the DT-AS; and
setting the IP address and/or the port number of the DT-AS that are/is in the trigger message to a preset IP address and/or a preset port number respectively, such that when a message is received using the preset IP address and/or the preset port number, the DT-AS can identify the message as the trigger message.

4. The method according to claim 2, wherein acquiring, by the third-party AS, the IP address of the DT-AS and/or the port number of the DT-AS comprises acquiring the IP address and/or the port number of the DT-AS that are/is preset in the third-party AS.

5. The method according to claim 2, wherein acquiring, by the third-party AS, the IP address of the DT-AS and/or the port number of the DT-AS comprises:
acquiring an external IP address, of the M2M UE, preset in the third-party AS; and
sending the external IP address to a domain name server (DNS) in order to acquire, by means of parsing, the IP address of the DT-AS.

6. The method according to claim 1, wherein the third-party AS communicates with the DT-AS using a diameter protocol or a hypertext transfer protocol (HTTP).

7. A method for sending a trigger message, comprising:
receiving, by a device trigger application server (DT-AS), the trigger message sent by a third-party application server (AS), wherein the trigger message comprises at least an identifier of machine-to-machine communications user equipment (M2M UE);
determining, according to the identifier of the M2M UE, whether the M2M UE has registered with the DT-AS;
sending the trigger message to the M2M UE corresponding to the identifier of the M2M UE when the M2M UE has registered with the DT-AS;
receiving, by the DT-AS, another message that is sent by the M2M UE in response to the trigger message; and
sending, by the DT-AS, to the third-party AS, the message in response to the trigger message, wherein the M2M UE is connected to a network at which the DT-AS is located, wherein the DT-AS is a server in a third Generation Partnership Project (3GPP) network, and wherein the third-party AS is a machine-to-machine communications (M2M) server outside the 3GPP network.

8. The method according to claim 7, wherein after receiving, by the DT-AS, the trigger message sent by the third-party AS, the method further comprises identifying the trigger message according to a preset specific identifier carried in the trigger message.

9. The method according to claim 7, wherein after receiving, by the DT-AS, the trigger message sent by the third-party AS, the method further comprises identifying the trigger message according to an Internet Protocol (IP) address of the third-party AS and/or a port number of the DT-AS that are/is preset in the trigger message.

10. The method according to claim 7, wherein after receiving, by the DT-AS, the trigger message sent by the third-party AS, the method further comprises identifying, by the DT-AS, a message as the trigger message when the message is received using a preset Internet Protocol (IP) address and/or a preset port number.

11. The method according to claim 7, wherein the third-party AS communicates with the DT-AS using a diameter protocol or a hypertext transfer protocol (HTTP).

12. An application server, wherein the application server is a third-party application server (AS), comprising:
a memory; and
a processor coupled to the memory, wherein the processor is configured to:
send a trigger message to a device trigger application server (DT-AS) by the third-party AS, when the third-party AS needs to establish a connection with machine-to-machine communications user equipment (M2M UE), wherein the trigger message comprises at least an identifier of the M2M UE, such that the DT-AS determines, according to the identifier of the M2M UE, whether the M2M UE has registered with the DT-AS, and wherein when the M2M UE has registered with the DT-AS, sends the trigger message to the M2M UE, receives a message that is sent by the M2M UE in response to the trigger message, and sends, to the third-party AS, the message in response to the trigger message; and
receive the message that is sent by the DT-AS in response to the trigger message, wherein the M2M UE is connected to a network at which the DT-AS is located, wherein the DT-AS is a server in a third Generation Partnership Project (3GPP) network, and wherein the third-party AS is a machine-to-machine communications (M2M) server outside the 3GPP network.

13. The application server according to claim 12, wherein the processor is further configured to: acquire an Internet Protocol (IP) address of the DT-AS and/or a port number of the DT-AS; and
set an IP address of the third-party AS and/or the port number of the DT-AS that are/is in the trigger message to a preset value or values, wherein the preset value or values is/are used by the DT-AS to identify the trigger message.

14. The application server according to claim 12, wherein the processor is further configured to:
acquire an Internet Protocol (IP) address of the DT-AS and/or a port number of the DT-AS; and
set the IP address and/or the port number of the DT-AS that are/is in the trigger message to a preset IP address and/or a preset port number respectively, such that when a message is received using the preset IP address and/or the preset port number, the DT-AS can identify the message as the trigger message.

15. The application server according to claim 13, wherein the processor is further configured to acquire the IP address and/or the port number of the DT-AS that are/is preset in the third-party AS.

16. The application server according to claim 13, wherein the processor is further configured to:
acquire an external IP address, of the M2M UE, preset in the third-party AS; and
send the external IP address to a domain name server (DNS) in order to acquire, by means of parsing, the IP address of the DT-AS.

17. The application server according to claim 12, wherein the third-party AS communicates with the DT-AS using a diameter protocol or a hypertext transfer protocol (HTTP).

18. A device trigger application server (DT-AS), comprising:
a memory; and
a processor coupled to the memory, wherein the processor is configured to:
receive a trigger message sent by a third-party application server (AS), wherein the trigger message comprises at least an identifier of machine-to-machine communications user equipment (M2M UE);
determine, according to the identifier of the M2M UE, whether the M2M UE has registered with the DT-AS;
send the trigger message to the M2M UE corresponding to the identifier of the M2M UE when the M2M UE has registered with the DT-AS;
receive another message that is sent by the M2M UE in response to the trigger message; and
send, to the third-party AS, the message in response to the trigger message, wherein the trigger message comprises at least the identifier of the M2M UE, wherein the M2M UE is connected to a network at which the DT-AS is located, wherein the DT-AS is a server in a third Generation Partnership Project (3GPP) network, and wherein the third-party AS is a machine-to-machine communications (M2M) server outside the 3GPP network.

19. The DT-AS according to claim 18, wherein the processor is further configured to:
identify the trigger message according to a preset specific identifier carried in the trigger message; or
identify the trigger message according to an Internet Protocol (IP) address of the third-party AS and/or a port number of the DT-AS that are/is preset in the trigger message; or
identify a message as the trigger message, when the message is received using a preset IP address and/or a preset port number.

20. The device trigger application server according to claim 18, wherein the third-party AS communicates with the DT-AS using a diameter protocol or a hypertext transfer protocol (HTTP).
